(19) United States
(12) Patent Application Publication
(10) Pub. No.: US 2017/0084950 A1
(43) Pub. Date: Mar. 23, 2017

(54) A SOLID POLYMER ELECTROLYTE AND A COMPOUND USED FOR THE ELECTROLYTE

(71) Applicant: Dow Global Technologies LLC, Midland, MI (US)

(72) Inventors: Yang Li, Shanghai (CN); Jianping Xu, Shanghai (CN); Wei Li, Shanghai (CN); Ling Yuan, Shanghai (CN); Deidre A. Strand, San Diego, CA (US); Qingshan Niu, Shanghai (CN)

(21) Appl. No.: 15/312,394

(22) PCT Filed: Jun. 4, 2014
(86) PCT No.: PCT/CN2014/079140

§ 371 Date: Nov. 18, 2016

(51) Int. Cl. H01M 10/0565; H01M 10/0525; B01J 39/19; C08G 63/91; C08J 5/22

(52) U.S. Cl. CPC H01M 10/0565; C08G 63/912; C08J 5/2256; B01J 39/19; H01M 10/0525; C08J 2367/04; H01M 2300/0082

(57) ABSTRACT

Solid polymer electrolyte and compound used for thereof are disclosed. The compound has a dendritic macromolecule and a cationic metal. The solid polymer electrolyte has increased ion conductivity even if the electrolyte is used at low temperature. Said solid polymer electrolyte is useful for a secondary battery.

### FIELD OF THE INVENTION

The invention is directed to a solid polymer electrolyte of a secondary battery and a compound useful for the electrolyte. More particularly, the invention relates to a solid polymer electrolyte comprising a compound containing a dendritic macromolecule and a cationic metal which has high ion conductivity even if it is used at low temperature.

### BACKGROUND OF THE INVENTION

Secondary batteries have been used as energy storage and power supply devices since the 1990s, especially for portable devices, like cell phones, notebook computers and power tools. Lithium ion batteries are widely used as secondary batteries because of their high energy density. The traditional lithium ion battery comprises a liquid electrolyte having lithium salts dissolved in an organic solvent, such as polar and aprotic carbonates.

However, the liquid organic solvent electrolyte may lead to and cause an explosion or fire. To address these problems, solid electrolytes have been developed as a possible alternative.

Solid polymer electrolytes have been developed as an alternative to liquid electrolytes. Solid polymer electrolytes have decreased risk of fires or explosions from leakage of flammable liquids while also being easy to process. Solid electrolyte batteries, however, due to their low ion conductivity especially at low temperatures make them impractical. For example, some solid polymer electrolytes such as a copolymer having polyalkylene oxide structure have been described by US2007/0190428A, US2009/0176161A, JP2008218404A and ACTA POLYMERICA SINICA, 2004, 1, 114. However, the ion conductivity of those electrolytes at low temperatures is poor or they require an organic solvent such as ethylene carbonate.

Therefore, it would be highly desirable to develop a solid polymer electrolyte with improved ion conductivity even at low temperatures such as at room temperature.

### SUMMARY OF THE INVENTION

The inventors have discovered that a compound which has a dendritic macromolecule comprising a polyoxy alkylene backbone and at least one cationic metal can realize improved ion conductivity at low temperatures. Surprisingly the compound has been found to have sufficient ion conductivity, so the compound can be used as a single ion conductor solid polymer electrolyte.

In a single ion conductor, anions are connected to a polymer matrix and only cations move in an electrolyte. Therefore, single ion conductor solid polymer of this invention can avoid the problem resulting from concentration gradients of the salt causing cell polarization that occurs when binary salt electrolytes are used. In addition, the cation transference number of a single ion conductor is close to 1 resulting in a quite efficient electrolyte.

### DETAILED DESCRIPTION OF THE INVENTION

As used throughout this specification, the abbreviations given below have the following meanings, unless the context clearly indicates otherwise: Mw=weight average molecular weight; EO=ethylene oxide; PO=propylene oxide; wt %=weight percent; g=gram; mg=milligram; mm=millimeter; μm=micrometer; min.=minute(s); s.=sec.=second(s); hr.=hour(s); ° C.=degree Centigrade; S/cm=Siemens per centimeter. Throughout this specification, the words “hyperbranched polymer”, “dendritic polymer” and “dendritic macromolecule” are used interchangeably. Throughout this specification, the words “alkylene oxide”, “alkoxide”, “oxyalkylene” and “alkylene glycol” are used interchangeably. Throughout this specification, the words “polyalkylene oxide”, “polyalkoxide” “polyoxyalkylene” and “poly alkylene glycol” are used interchangeably.

Compound

The compound of this invention comprises a dendritic macromolecule and a cationic metal within the structure. The dendritic macromolecule has a highly branched structure with three-dimensional dendritic architecture while related-art polymers such as a copolymer generally have a string form. Because of the dendritic structure, the dendritic macromolecule has been discovered to display desirable properties such as; low viscosity, amorphous structure, small size, a minimal entanglement of molecules, and capability of forming a surface having many functional groups.

The dendritic macromolecule of the compound for this invention comprises an oxyalkylene group within the structure. The oxyalkylene preferably includes an alkylene oxide having from 2 to 8 carbon atoms. Examples of the alkylene oxide include ethylene oxide and propylene oxide. The dendritic macromolecule has at least one oxyalkylene group. Preferably, the dendritic macromolecule has 2 or more of oxyalkylene groups, more preferably it has 4 or more of oxyalkylene groups.

The dendritic macromolecule of the compound preferably is comprised of a carboxyl group within the structure. More preferably, the dendritic macromolecule has two or more of carboxyl groups, further preferably it has 4 or more of carboxyl groups, even more preferably it has 8 or more of carboxyl groups.

Each end of the dendritic macromolecule can be an organic group having an anionic charge. The organic group can be combined to a cationic metal which is another element of the compound of this invention. Preferably, at least 30% of ends of the dendritic macromolecule are organic groups having an anionic charge, and more preferably 50% or more, most preferably 70% or more of the ends are organic groups having an anionic charge. Examples of such organic groups having an anionic charge include a sulfate group, sulfamate group, phosphate group and phosphoramide group. Preferably, the organic group is a sulfate group, sulfamate group or combination thereof.

The compound of this invention has at least one cationic metal within the structure. Preferably, the compound has at least 2 cationic metals, more preferably it has at least 4 cationic metals, and most preferably it has at least 6 cationic metals within the molecule. Examples of the cationic metal include lithium, sodium, potassium, magnesium, aluminum and cesium. Preferably the cationic metal is selected from lithium, sodium and potassium, and most preferably the cationic metal is lithium. Preferably, at least 30% of the organic groups having an anionic charge are combined to cationic metals, and more preferably 50% or more, most preferably 70% or more of organic groups are combined to cationic metals.

Most preferably, the compound has the following formula (1).

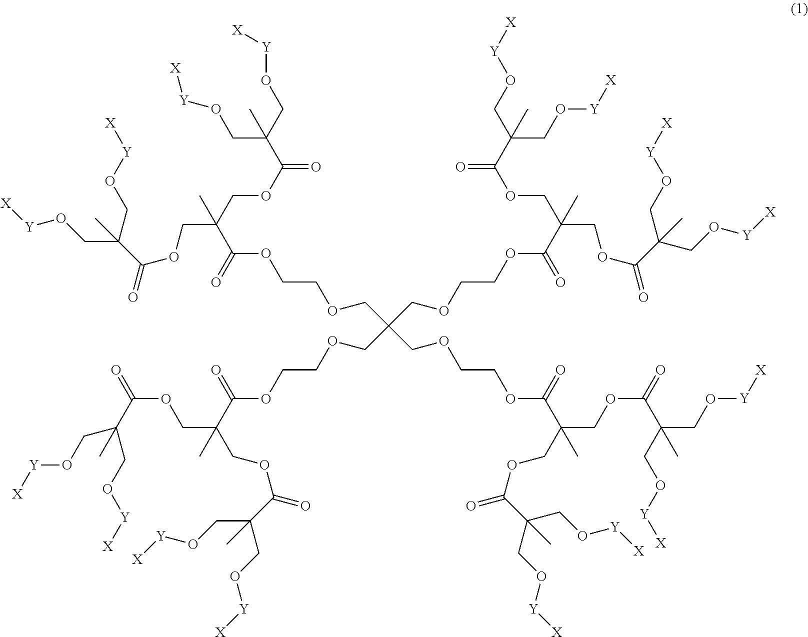

In formula (1), Y is an organic group having anionic charge, and X is a metal having a cationic charge.

Illustratively, any particularly may be any one of the following: a sulfate group, sulfamate group, phosphate group or phosphoramide group. Preferably, any particular Y is either a sulfate group or sulfamate group.

Illustratively, any particular X may be any alkali or alkaline earth metal. Preferably, any particular X may be lithium, sodium or potassium. More preferably Y is lithium.

The dendritic macromolecule of the compound preferably has an weight average molecular weight (Mw) of 1,000 or more Most preferably, the Mw is 1,500 or more. The Mw is preferably 8,000 or less.

The compound of this invention may be synthesized by any suitable method. Commercially available dendritic macromolecules lacking the desired end groups may be used to synthesize the dendritic macromolecule. Examples of such dendritic macromolecule include Bolton dendritic polymers such as Bolton H20, which has hydroxyl end groups. Illustratively, when the desired macromolecule of this invention is the molecule shown in formula (1) and each Y and X of the formula (1) are a sulfate group and lithium respectively, the method for the synthesis of the compound may be formed as shown below:

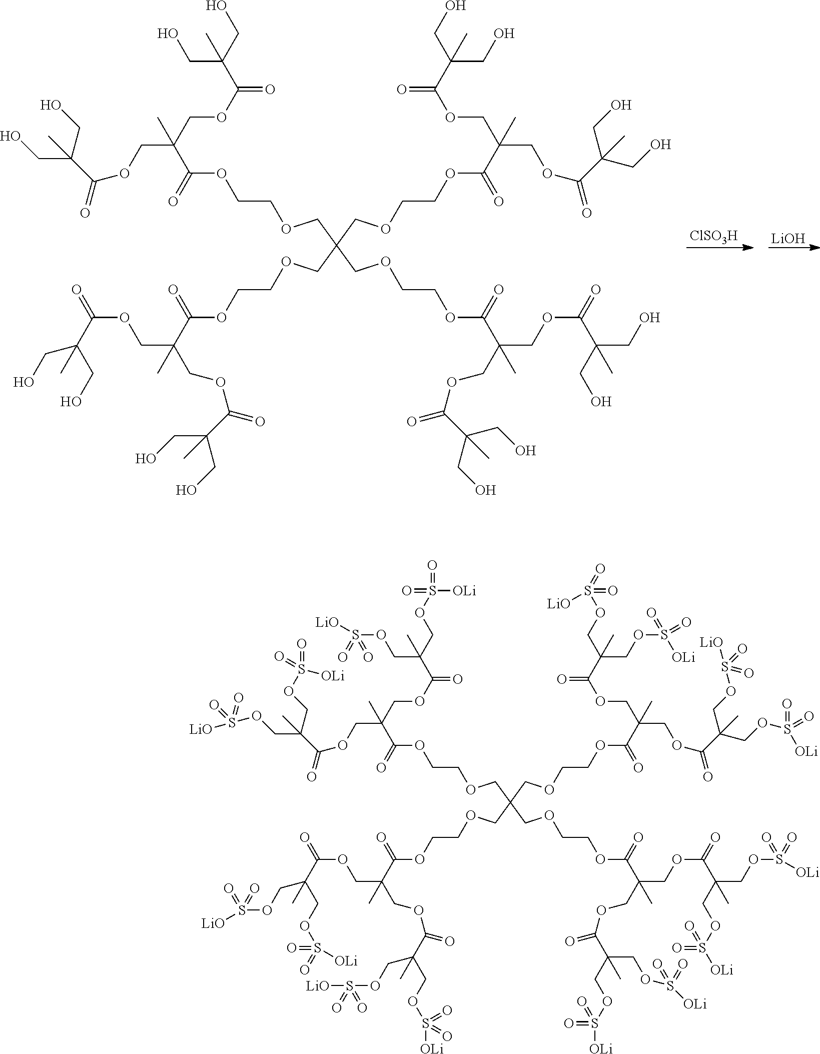

Hydroxyl groups of Bolton H20 dendritic polymer are sulfated using a sulfonation agent, then neutralized. For example, the dendritic polymer is reacted with CISO₃H in dimethyl formamide (DMF) solution at 0 to 30° C. for 12 to 48 hours, then the reaction compound is neutralized by lithium hydroxide aqueous solution at 10 to 30° C.

Electrolyte

Electrolyte of the invention is a solid polymer electrolyte and comprising the compound disclosed above. The “solid polymer electrolyte” includes solid and gel state polymer electrolyte. The electrolyte may further comprise a solvating polymer, inorganic filler or other additives.

The solvating polymer is a polymer that further increases the ion conductivity of the electrolyte. Examples of the solvating polymer include polyalkylene oxide such as ethylene oxide homopolymers and copolymers. Preferably the solvating polymer is polyethylene oxide. The molecular weight of the solvating polymer is preferably 100,000 g/mol or more, more preferably 500,000 g/mol or more.

The ratio of the molar concentration of oxygen atoms from the solvating polymer to the molar concentration of cationic metals of the compound is shown as EO/M ratio. For lithium ion, the ratio is shown as EO/Li ratio. Preferably the EO/M ratio is 1/1 or more, more preferably 2/1 or more, even more preferably 4/1 or more, and the most preferably 10/1 or more. Preferred EO/M ratio is 120/1 or less, more preferably 80/1 or less, even more preferably 60/1 or less, even more preferably 40/1 or less, and the most preferably 30/1 or less. If the ratio is more than 120/1, the ion conductivity of the electrolyte will decrease. If the ratio is less than 1/1, it is difficult to form a film.

Inorganic filler may be used if desired, for example, to improve the mechanical strength or further increase the ion conductivity of the composition. Examples of the inorganic filler include SiO₂, ZrO₂, ZnO, CNT (carbon nanotube), TiO₂, CaCO₃, Al₂O₃ and B₂O₃. When inorganic filler is used, the content of the inorganic filler is preferably 0.1 wt % or more, more preferably 0.5 wt % or more, and most preferably 1 wt % or more based on the weight of the composition. The content of the inorganic filler is preferably 100 wt % or less, more preferably 50 wt % or less, and most preferably 30 wt % or less based on the weight of the composition.

The electrolyte may comprise other additives such as a crosslinking agent or ionic liquid. Typically, the crosslinking agent has at least two cross-linkable groups and it can be crosslinked by itself or crosslinked with dendritic macromolecule or solvating polymer. Therefore, the crosslinking agent may increase the mechanical strength of electrolyte. Examples of cross-linkable groups include acrylic group, methacrylic group, vinyl group, glycidyl group, anhydride group and isocyanate group. Examples of an ionic liquid include 1-allyl-3-methylimidazolium chloride, tetraalkylammonium alkylphosphate, 1-ethyl-3-methylimidazolium propionate, 1-methyl-3-methylimidazolium formate and 1-propyl-3-methylimidazolium formate. The ionic liquid may be used alone or with a conventional liquid electrolyte to prepare a gel electrolyte.

Since the electrolyte of the invention is a solid polymer electrolyte, it does not include organic solvents such as ethylene carbonate (EC) or propylene carbonate (PO) which are usually used in a conventional liquid electrolyte avoiding problems of leakage and potential fires and explosions that can occur from such leakage.

The electrolyte of this invention has a high ion conductivity at low temperatures such as at room temperature. Conventional solid polymer electrolyte comprising a copolymer having polyoxyalkylene block shows sufficient ion conductivity at high temperature such as 60° C. or more, but its ion conductivity decreases at lower temperatures such as room temperature. It is a problem for the practical use of a battery, because many electronics devices are used around room temperature. Therefore, the electrolyte of this invention has an advantage over the conventional solid polymer electrolyte. Not bound to the theory and not limiting the invention in any way, the inventors believe that a hyperconjugative interaction exists in the anionic group of the compound, which exhibits good delocalized properties that may lead to the observed ion conductivity. That is, the anionic group helps disassociation of the cationic metal in the electrolyte, thus facilitating the transportation of cationic metal resulting in higher ion conductivity at lower temperatures.

The electrolyte of this invention can be used in any form, but sheets are preferable for use of electrolyte in a battery.

Battery

The solid polymer electrolyte of this invention may be used as an electrolyte in a secondary lithium ion battery cell including at least one anode, at least one cathode, one or more current collectors, and optionally a separator, all in a suitable housing. Since the electrolyte of this invention is a solid polymer electrolyte, the risk of leakage of liquid electrolyte is less. In addition, the electrolyte of this intention has high ion conductivity at low temperatures such as room temperature. It has many advantages and may be used for providing power to a mobile device, such as a cell phone, a vehicle, a portable device for recording or playing sound or images such as a camera, a video camera, a portable music or video player, a portable computer and the like.

### EXAMPLES

### Example 1 (Inventive Example)

Preparation of a dendritic macromolecule modified lithium sulfate monoester (LiBH₂₀SUM)

2.0 g of Boltorn® H20 dendritic polymer (available from Perstorp company, molecular weight is 1747g/mole, comprising theoretically 16 primary hydroxyl groups) was dried first in vacuum over 24 hours, and then dissolved into 9 ml of dimethyl formamide (DMF). 2.0 g of chlorosulfonic acid was mixed with 6 ml of DMF at 0° C., and then added dropwise to the DMF solution of Boltorn® H20. After being stirred over 24 hours, the solution was neutralized using 10% of lithium hydroxide aqueous solution and the solvents were evaporated by vacuum evaporator. The product was precipitated by ethanol/acetone solution. After being dried in a vacuum at 70° C. for 24 h, the white powder was obtained and stored in glove-box. Analyzed lithium content (ICP) was 3.58%, theoretical content is 3.63%, which means that about 98.6% of hydroxyl groups were modified with sulfate monoester.

Preparation of Electrolyte Film

50 mg of the above prepared dendritic macromolecule (LiBH₂₀SUM) and 2.5g of 5 wt % polyethylene glycol (PEG, Mw is 600,000, available from ACROS company) acetonitrile solution were dissolved in 2 ml of ethanol at 25° C. and stirred for 120 minutes to form a homogeneous solution. The mixture was poured on a Teflon™ plate and heated under reduced pressure at 60° C. over 24 hours to remove the solvent. A film was obtained on the PTFE plate. The thickness of the obtained film was 10 to 100 μm. The EO/Li ratio was 11/1. The film was cut into specimens with diameters of 18 mm. The obtained polymer electrolyte was measured for its ion conductivity. Result is shown in Table 1.

Measurement of Ion Conductivity

The ion conductivity of an electrolyte was measured using AC impedance spectroscopy in a Princeton 2273 using alternating current (AC) amplitude of about 10 mV. Details of the AC impedance spectroscopy method are in Handbook of Batteries, 3rd Ed; David Linden and Thomas Reddy, Editors, McGraw-Hill, 2001, New York, NY, pp. 2.26 -2.29, incorporated herein by reference.

### Example 2 (Inventive Example)

Preparation of a dendritic macromolecule modified lithium sulfamate (LiBH₂₀SA)

The same procedure as in Example 1 was conducted except that 2.0 g of sulfamoyl chloride was used instead of chlorosulfonic acid. After being dried in a vacuum at 60° C. for 24 h, the white powder was obtained and stored in glove-box. Analyzed lithium content (ICP) was 2.22%, theoretical content is 3.65%. This means that about 61% hydroxyl groups were modified with sulfamate.

Electrolyte film was prepared the same as in Example 1 except that LiBH₂₀SA was used instead of LiBH₂₀SUM and the weight of 5wt % PEG solution was changed to 2.6 g. The EO/Li ratio was 15/1. The obtained polymer electrolyte was measured for its ion conductivity and the result is shown in Table 1.

### Example 3 (Comparative Example)

Preparation of lithium sulfate monomethylester (Li SUM)

A compound having lithium sulfate but small molecule was prepared to compare with Inventive Example 1. Chlorosulfonic acid (10.0 g, 85.8 mmol) was added dropwise to methanol (5.0 g, 156.2 mmol) at 0° C. After being stirred overnight, the excessive methanol was evaporated in a vacuum; the residue was dissolved into water and neutralized with 1 equivalent of lithium hydroxide. The water was evaporated in a vacuum and extracted with acetonitrile. After the evaporation of acetonitrile, lithium sulfate monomethylester was obtained as white crystal. ¹H NMR (d⁶-DMSO, ppm): 3.40 (s, 3H); ESI-MS: 110.976(M-H)⁻, theoretical mass 110.980; Analyzed lithium content (ICP) was 5.47%, while theoretical content is 5.93%.

Electrolyte film was prepared the same as in Example 1 except that Li SUM was used instead of LiBH₂₀SUM and the weight of 5wt % PEG solution was changed to 5.4 g. The EO/Li ratio was 16/1. The obtained polymer electrolyte was measured for its ion conductivity and the result is shown in Table 1.

### Example 4 (Comparative Example)

Preparation of lithium 2,2,2-trichloroethyl sulfamate (LiTCSA)

2,2,2-trichloroethyl sulfamate (0.5 g, 2.19 mmol) and 1 equivalent of lithium hydride were mixed in acetonitrile and then stirred overnight at room temperature. After filtration through a filter (Rephile RF-Jet PTFE 0.45 μm), the resulting solution was evaporated in vacuum and dried. ¹H NMR (d⁶-DMSO, ppm): 4.40 (s, 2H), 4.00 (s, 1H); ESI-MS: 225.890 (M-H)⁻, theoretical mass 225.900; Analyzed lithium content (ICP) was 2.33% while theoretical content is 3.00%.

Electrolyte film was prepared the same as in Example 1 except that LiTCSA was used instead of LiBH₂₀SUM and the weight of 5wt % PEG solution was changed to 3.0 g. The EO/Li ratio was 16/1. The obtained polymer electrolyte was measured for its ion conductivity and the result is shown in Table 1.

### Example 5 (Comparative Example)

Preparation of electrolyte film comprising commercial available LiTFSI

Conventional electrolyte film was prepared to compare with the invention. 52 mg lithium bis(trifluoromethanesulfonyl)imide and 2.5 g 5 wt % PEG acetonitrile solution were dissolved in acetonitrile by magnetic stirring to form a homogeneous solution. The resulting suspension was then cast into Teflon plates. The solvent was removed under reduced pressure at 60° C. for 24 h and SPE membrane based LiTFSI and PEO was obtained. The EO/Li ratio was 16/1.

TABLE 1

| | | | Ion conductivity |
|---|---|---|---|
| | | | in PEO |
| | | | matrix, σ@30° C. |
| Examples | Lithium salt | Type of lithium salt | (S cm⁻¹) |
| 1 | LiBH₂₀SUM | Hyper-branched, single | 3.0 × 10⁻⁵ |
| | | ion conductor | |
| 2 | LiBH₂₀SA | Hyper-branched, single | 2.3 × 10⁻⁶ |
| | | ion conductor | |
| 3 | LiSUM | Small molecule | 1.4 × 10⁻⁵ |
| 4 | LiTCSA | Small molecule | 1.6 × 10⁻⁶ |
| 5 | LiTFSI | Small molecule | 3.7 × 10⁻⁶ |

1. A solid polymer electrolyte comprising a compound having a dendritic macromolecule and a cationic metal.

2. The solid polymer electrolyte of claim 1, wherein the compound has a carboxyl group and an alkylene oxide group.

3. The solid polymer electrolyte of claim 1, wherein the cationic metal is lithium.

4. The solid polymer electrolyte of claim 1, wherein the weight average molecular weight of the compound is 1,500 or more.

5. The solid polymer electrolyte of claim 1, further comprising polyalkylene oxide.

6. A secondary lithium ion battery comprising the solid polymer electrolyte of claim 1.

7. A compound comprising a dendritic macromolecule and a lithium, wherein the compound has a carboxyl group and an alkylene oxide group.

8. The compound of claim 7, wherein the compound has lithium sulfamate.

9. The compound of claim 7, wherein the weight average molecular weight of the compound is 1,500 or more.
